(19) United States
(12) Patent Application Publication
(10) Pub. No.: US 2018/0227595 A1
(43) Pub. Date: Aug. 9, 2018

(54) COMPRESSOR

(71) Applicant: Forbidden Technologies plc, Wimbledon, London (GB)

(72) Inventor: Stephen Streater, London (GB)

(21) Appl. No.: 15/749,360

(22) PCT Filed: Jul. 22, 2016
(86) PCT No.: PCT/GB2016/052223

§ 371 Date: Jan. 31, 2018

(30) Foreign Application Priority Data
Jul. 31, 2015 (GB) 1513610.4

(51) Int. Cl. H04N 19/58; H04N 19/513; H04N 19/119; H04N 19/59; H04N 19/176

(52) U.S. Cl. CPC H04N 19/58; H04N 19/521; H04N 19/176; H04N 19/59; H04N 19/119

(57) ABSTRACT

A method of encoding a series of frames in a video or media, including receiving a first key frame, receiving subsequent chunks of frames including at least one key frame, dividing each frame into a plurality of blocks, subdividing a first block (110) of the plurality of blocks into a plurality of pixel groups, averaging the pixels in each pixel group (112) to generate a single value, creating a first mini-block wherein each element of said first mini block corresponds with a pixel group of the corresponding first block and contains said single value, repeating for each block of each frame of the chunk, comparing a first of said plurality of mini blocks of a first frame with mini blocks of a second frame, where said second frame mini blocks are not necessarily aligned to mini blocks in the first frame, until a best match is achieved.

### BACKGROUND

Historically, video was principally professionally made, using expensive (and heavy) cameras, usually sitting on expensive and very stable tripods. One effect of this was to bias the video content itself to contain little camera movement, with relatively little camera acceleration and almost no camera rotation. Traditional video codecs, such as MPEG, meet the need for streaming such content.

The arrival of camera phones is changing the way video is made. Now, the cameras themselves have relatively low mass compared with traditional cameras, and in general use are often moved erratically—with pans, rotation and, in the case of selfies in particular, rapid zooms. In addition, the relatively small lenses restrict the light which can reach the sensor, making the source content often noisier than on a professional camera. In addition, despite all the additional complications with the source content, mobile devices have limited and sometimes expensive bandwidth and limited processing power. This invention is a video codec designed to address, amongst other things, issues relating to real time capture, compression, sharing and playback of video over limited bandwidth on a modern mobile phone.

For the purposes of this patent, I have called the invention described herein “Blackbird 8”.

### Statement of Invention

The present invention, in accordance with a first aspect is directed to a method of encoding a series of frames in a video or media, including receiving a first key frame, receiving subsequent chunks of frames including at least one key frame, dividing each frame into a plurality of blocks, subdividing a first block of the plurality of blocks into a plurality of pixel groups, and averaging the pixels in each pixel group to generate a single value. The method further includes creating a first mini-block wherein each element of the first mini block corresponds with a pixel group of the corresponding first block and contains the single value, and repeating for each block of each frame of the chunk, and comparing a first of said plurality of mini blocks of a first frame with mini blocks of a second frame, where said second frame mini blocks are not necessarily aligned to mini blocks in the first frame, until a best match is achieved.

Preferably the method further comprises the steps of generating a motion vector to map said first mini block of the first frame to the best match mini block of the second frame.

Preferably the method further comprises generating respective motion vectors to map respective mini blocks of a first frame onto respective achieved best matches of a second frame.

Preferably the achieving a best match relies on an error function.

Preferably the error function includes utilising mean square error or errors between pixel values from the first frame and pixel values from the second frame.

Preferably the first frame is a temporally earlier frame than the second frame of the chunk of frames.

Preferably the first frame is a temporally nearest earlier frame to the second frame of said chunk of frames.

Preferably the first frame is a temporally later frame than the second frame of the chunk of frames.

Preferably the first frame is a temporally nearest later frame to the second frame of the chunk of frames.

Preferably the motion vectors are based on a combination of a temporally earlier and a temporally later frame to the second frame of said chunk of frames.

Preferably separate motion vectors are based on a temporally nearest earlier frame and a temporally nearest later frame to the second frame of the chunk of frames.

Preferably the method further comprises recalculating each mini block of the first frame to be an integer multiple larger, to provide a larger mini block, and comparing each larger mini block of the first frame with the comparisons of larger mini blocks starting in the vicinity of the best match mini block of the second frame, not necessarily aligned to tiled larger block positions, to find a better best match.

Preferably the recalculating step is repeated until the mini block size is the same as the block size, and each pixel being compared is an original pixel not an averaged pixel.

Preferably the step of comparing a first of said plurality of mini blocks of a first frame with respective mini blocks of a second frame includes comparing the first mini block with a mini block in a corresponding position in a second frame, then comparing the first mini block with a block in the second frame with a displacement where both the horizontal and vertical components of the displacement are integer numbers of pixels from the mini block in a corresponding position in the second frame.

Preferably the step of comparing a first of the plurality of mini blocks of a first frame with respective mini blocks of a second frame includes comparing the first mini block with a mini block in a corresponding position in a second frame, then comparing the first mini block with a block in the second frame with a displacement where both the horizontal and vertical components of the displacement are integer numbers of pixels from the mini block in a corresponding position in the second frame.

Preferably the integer number of pixels is one pixel.

Preferably the integer number of pixels is a plurality of pixels.

Preferably the pixel displacement is in a vertical direction. Preferably the pixel displacement is in a horizontal direction. Preferably the pixel displacements are in a horizontal and a vertical direction.

Preferably encoding the chunk of frames includes providing a key frame and motion vectors derived from the comparisons.

Preferably encoding the chunk of frames includes providing block information.

Preferably the block information includes block size.

Preferably the block information indicates the block type such as whether the first frame is and earlier frame, a later frame, than the second frame or both an earlier frame and a later frame are used to generate separate vectors.

Preferably the comparing step is adapted to cover remote matches.

Preferably the encoding method includes an error function to estimate errors over the blocks.

Preferably the method includes filtering, but said filtering steps are carried out after the motion vectors are calculated.

Preferably the number of blocks is sufficient to ensure each block has a match on an earlier or later frame, or both.

Preferably all the blocks in a frame are the same size.

Preferably the block size is a divisor of the image size of the frame.

Preferably the blocks are sized to tile the respective frame.

Preferably all the blocks in all the frames in a chunk are the same size.

Preferably estimates of motion vectors for each frame where the binary number of the frame ends in a ‘1’ are generated in a first pass at a first magnification from raw data of said frame and from temporally adjacent, neighbouring frames, and estimates of motion vectors for each frame where the binary number of the frame ends in a ‘10’ is generated at a second, less granular, magnification from said earlier motion vector estimates, and each frame where the binary number of the frame ends in ‘100’, ‘1000’, 10000, and so on, this list of frame numbers continuing until the last power of two which is not a key frame, is generated at further, less granular, magnifications from earlier motion vector estimates until a final motion estimate for the frame mid-way between the first and last frame depends on earlier estimates, such that each motion vector estimate is based on values calculated from neighbouring estimates.

Preferably the method includes the further step of, before the frames of the chunk are encoded for transmission, reconstructing the video from the compressed chunk by applying the motion vectors thereto; comparing the result to the frames as they will be decompressed, adjusting the motion vectors to obtain a best result, and replacing the original frames to be compressed with the resulting decompressed frames to be used as this process continues.

Preferably the method further including the step of transmitting the encoded chunk, with at least one key frame and motion vector transmitted to the decoder for the decoder to reconstruct the chunk.

Preferably the method further includes the step of adding additional data when encoding, from any number of, bias information, gaps to correction, and corrections to temporal estimates.

Preferably the method includes the further step of receiving a compressed key frame, and at least one subsequent compressed encoded data chunk, including motion vector data, and applying relevant motion vectors to either one or both said key frames, or using other encoded intra frame data, to reconstruct a first delta frame.

Preferably the method further comprises constructing a subsequent delta frame from said constructed delta frame and relevant motion vectors.

Preferably the data chunk relates to an integer number of frames, wherein the number of frames is divisible by 2.

Preferably subsequent delta frames are constructed at mid-points between already constructed delta frames.

The present invention, in accordance with a second aspect, is directed to an apparatus for decoding a received compressed video or other media data, the compressed data including at least two key frames and information identifying, for frames compressed in the compressed data, a block size and, for each block, a block type, the block type indicating whether a first frame to be reconstructed is based on zero, one or two of an earlier or later second frame in the compressed data, motion vectors and other data, comprising: means to receive the compressed data; means to apply the motion vectors to the compressed data to reconstruct frames.

Preferably the apparatus is further adapted to reconstruct delta frames from key frames and the motion vectors.

Preferably the apparatus is further adapted to reconstruct delta frames utilising additional data.

Preferably the apparatus further comprises means to apply the motion vectors to reconstructed delta frames to generate further delta frames.

Preferably the apparatus is adapted to reconstruct delta frames until all the frames have been reconstructed.

Preferably the means is adapted to receive the data key frames first, followed by motion vectors for constructing delta frames therefrom.

Preferably the apparatus is further adapted to receive compressed data chunks including an integer number of frames.

Preferably the integer is a power of 2.

Preferably the delta frames are reconstructed to generate a video or media stream.

The present invention, in accordance with a third aspect is directed to a media player including an encoder as set out above.

The present invention, in accordance with a fourth aspect is directed to a media player including a decoder as set out above.

The present invention, in accordance with a fifth aspect is directed to an apparatus for carrying out any of the steps set out above.

Preferred embodiments of the present invention will now be described by way of example only and with reference to the accompanying drawings in which:

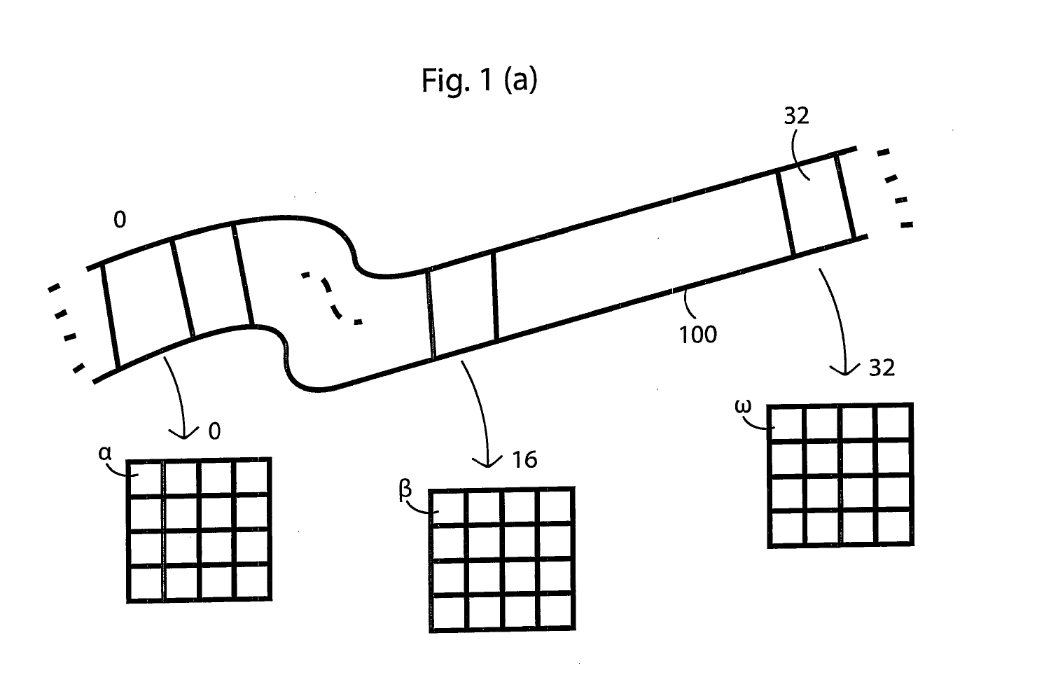

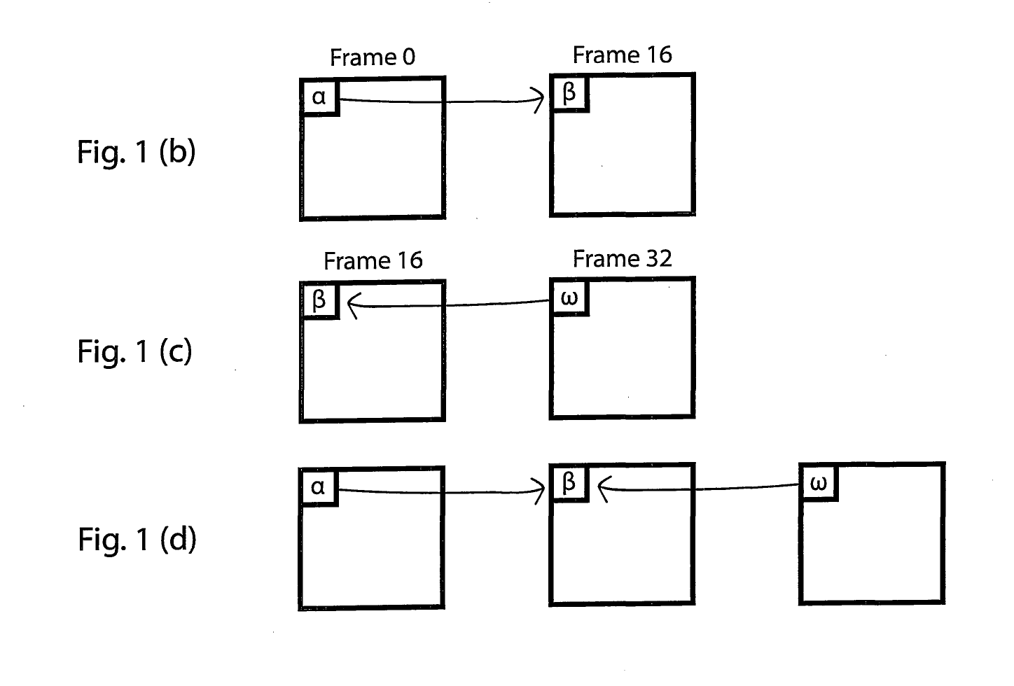

FIG. 1(a) shows a temporal sequence of frames of a video with frames split into blocks,

FIGS. 1(b)-(d) shows an exemplary variety of block representations,

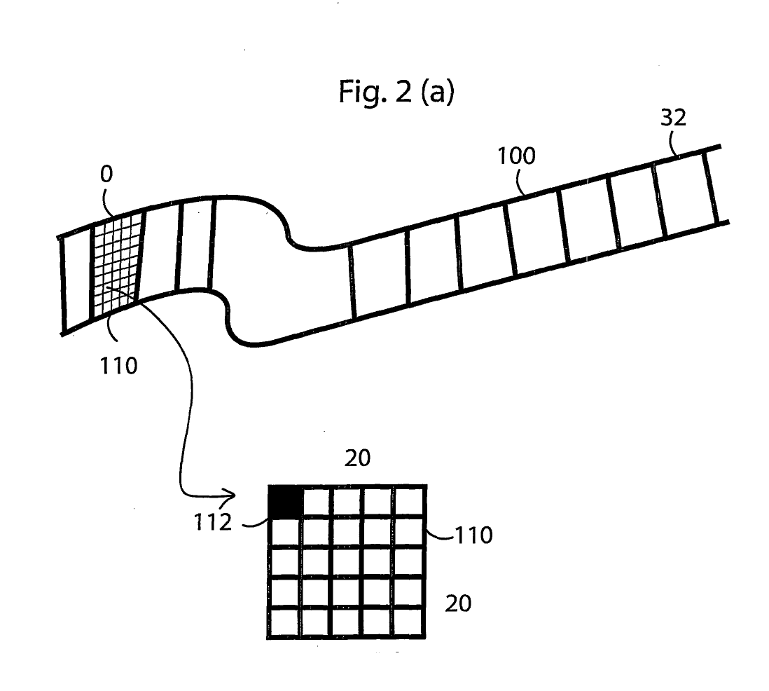

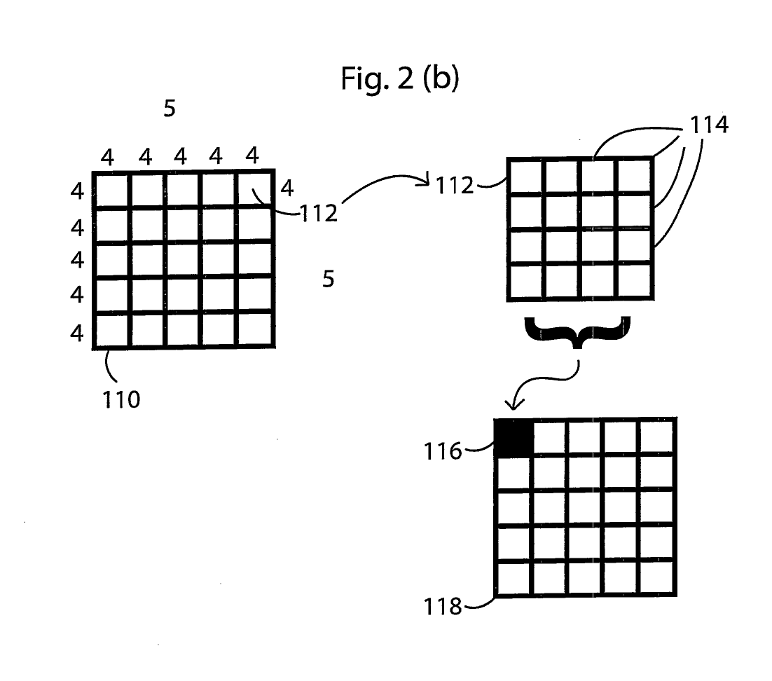

FIGS. 2(a) and (b) show the derivation of mini blocks from a frame,

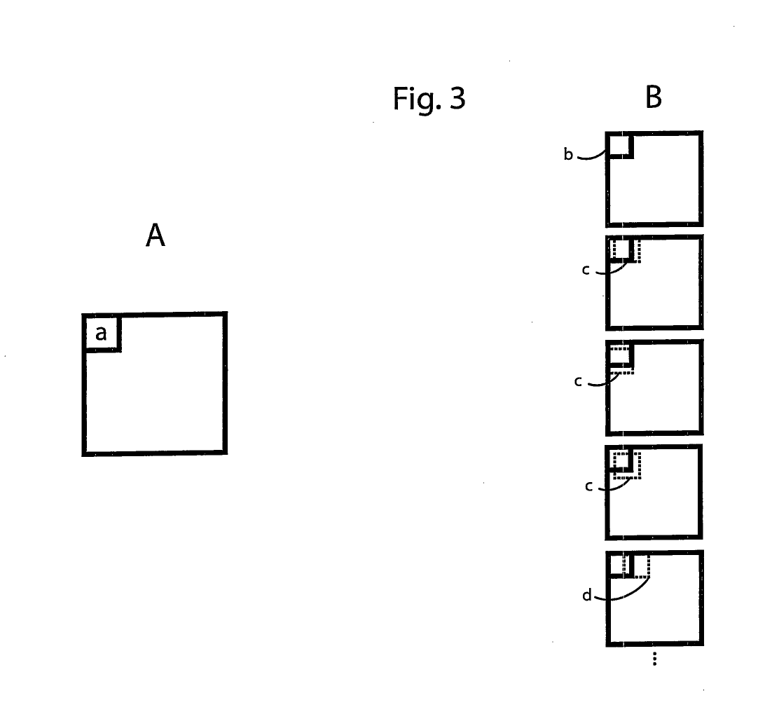

FIG. 3 shows the search pattern followed to reach a candidate motion vector, and

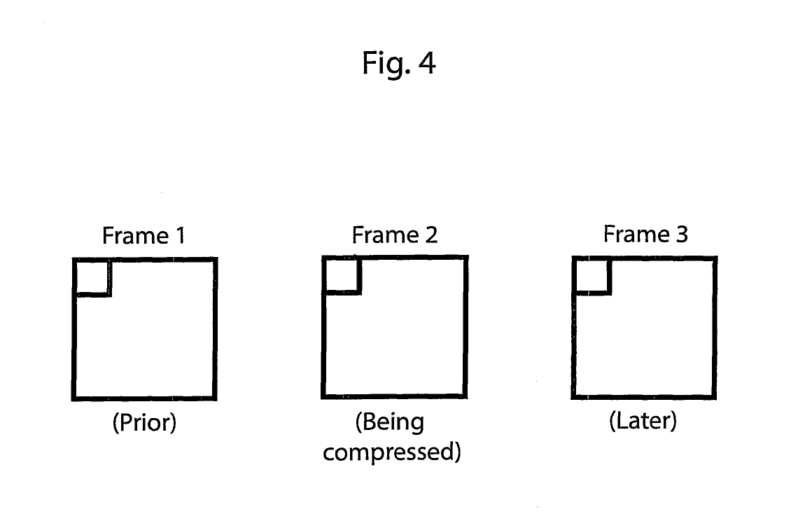

FIG. 4 shows frames adjacent to the frame being compressed.

### BITSTREAM FORMAT CAPABILITIES

The video codec has two parts—an encoder and a decoder. The decoder must be installed on all playback devices, so is not changed very often. The encoder, on the other hand, only has to be installed on the device making the recording. Provided the encoder stays compatible with the installed base of decoders, it can be changed at will, such as with each update to an app. In accordance with the present disclosure, the present invention (Blackbird 8) has a flexible bitstream format which allows refinements and variations to the compression, or encoding, without needing to change the decoders in any devices—though optimisations to the decoder which read the same or earlier bitstream formats are expected.

The bitstream format provides for videos of a wide range of sizes—such as but not limited to: 3840×2160 (4k), 1920×1080 (1080p), 1280×720 (720p), 640×360 (360p), 432×240, 384×288, 384×216, 320×240 and 320×180—in each case with the video frames split into preferably rectangular blocks. This can be seen in FIG. 1(a), which shows a temporal sequence of frames of a video, starting with frame 0 and ending with frame 32: FIG. 1(a) also shows a representation of frames 0 and 32 split into rectangular blocks.

The bitstream format includes information as to which of several pre-defined formats have been utilised for each block during encoding, and this information is available and used during decoding. In one format, shown in FIG. 1(b) the block representation is based on a block which has occurred earlier in the video, for example in FIG. 1(b) block β of frame 16 is based on block a of frame 0. In another case, shown in FIG. 1(c) the block representation is based on a block which occurs later in the video, for example in FIG. 1(c) block β of frame 16 is based on block ω of frame 32. In a third case, shown in FIG. 1(d) the block representation is based on information from both earlier and later blocks, for example in FIG. 1(d) block β of frame 16 is based on block α of frame 0 and block ω of frame 32. Note that in all representations the blocks on which a block β is based may not line up with the rectangular blocks which block α on frame zero or block ω on frame 32 are split up into. In a fourth representation, the block representation does not make use of information from either earlier or later blocks.

In addition, the bitstream format includes motion vectors, and the decoding steps include decoding such motion vectors for each block. The bitstream format may also contain simple adjustments across blocks which when decoded and applied, make decoded blocks a more accurate representation of the compressed block. In certain cases, for example in the fourth representation above, the decoding step includes decoding blocks which have been encoded utilising the intra frame compression option, for example utilised for any block whose compressed representation does not depend on any other frame or part of the frame.

Filter on Source

Forbidden's codecs have traditionally included a filter stage to remove noise. Filtering before knowledge of the motion adds compression artefacts to the video, and so to minimise these filtering artefacts caused by motion, in accordance with the present invention, filtering is applied after the motion estimation stages of the codec. The motion search which leads to the motion vectors for each block is quite accurate, and an advantage of filtering after motion estimation can be best illustrated by considering for example an image for an object which may be present in several frames. Each of the several frames will include information about the object and information may be combined and used or relied upon in any, some or all of the appropriate frames in order to create a temporally more consistent representation of the object—but only if the filter handles corresponding pixels from the version of each object in each frame, i.e. only if the filter is applied after motion compensation.

Compressor Chunks

The video frames can be thought of as being grouped in chunks. Each chunk contains a key frame and, apart from the earliest chunk, a number of delta frames. Referring again to FIG. 1(a), frames 0 (a first chunk) and 32 (part of a second chunk comprising frames 1 to 32) are contemplated to be key frames and all the frames 1 to 31 between, including frame 16, are contemplated to be delta frames. The number of frames between key frames is preferably one less than a power of two (a power of two if a key frame at one end is included), and then delta frames are recursively constructed from the nearest preceding and subsequent key frames and/or delta frames by subdividing the time between existing constructed frames by, for example, two and adding a frame at this time until all the frames at each separation are constructed.

For example, referring again to FIG. 1(a), when seeking to construct intermediate (delta) frames, the nearest preceding key frame is frame 0 and the nearest subsequent key frame is frame 32, so dividing the time between these two key frames by two and adding a frame at that time will provide us with frame 16, constructed from key frames 0 and 32. Delta frame 8 can then be constructed from nearest preceding key frame 0 and nearest subsequent delta frame 16, and in a similar manner all the frames intermediate frame 0 and frame 32 can be constructed.

The method of compression of the key frames, which use their own intra frame compression techniques, is not described in this invention, which covers the compression and decompression of the delta frames.

YUV

The luminance (Y) and the colour components (e.g. UV) can be compressed individually, or more efficiently from a data rate standpoint, together, in which case the motion vectors for each block are applied to Y, U and V.

Motion Search Blocks

As discussed, the video or other media being compressed is composed of frames, and in accordance with the present invention these frames are split into blocks each of which are contemplated to have their own motion vectors. It is convenient, though not necessary, for these blocks all to be the same size, and for this size to be a divisor of the image size. These blocks are additionally converted into mini blocks, where an integer number of blocks of the size of the mini blocks can tile a block the size of the bigger blocks. These blocks may be square, but this is not necessary.

For example only, some typical video images sizes are set out below, with corresponding big block and mini block sizes (in pixels). The invention is not limited to the exemplary image and block sizes set out herein.

Image size: 1920×1080 (1080p)

Big block size: 30×30

Small block size: 5×5

Image size: 1280×720 (720p)

Big block size: 20×20

Small block size: 4×4

Image size: 640×360 (360p)

Big block size: 20×20

Small block size: 5×5

Image size: 432×240

Big block size: 16×16

Small block size: 4×4

Image size: 384×288

Big block size: 16×16

Small block size: 4×4

Image size: 384×216

Big block size: 12×12

Small block size: 4×4

Image size: 320×240

Big block size: 16×16

Small block size: 4×4

Image size: 320×180

Big block size: 10×10

Small block size: 5×5

Implementation is simplest when the following conditions are met:

1. Big blocks tile the image (i.e. each frame of the video).

2. The horizontal and vertical pixel sizes of the mini blocks are divisors of the horizontal and vertical pixel sizes of the big blocks to which they correspond.

3. There are sufficient big blocks that each big block has a corresponding big block on earlier frames, later frames, or both, which match the similar image content.

4. The mini blocks are large enough to have enough content to match motion vectors accurately.

FIGS. 2(a) and (b) show the derivation of a mini block from a frame. FIG. 2(a) shows frame 0 of a video sequence divided into blocks. In this example, it is contemplated that each block (110) is a 20×20 block, which will include 400 (20×20) pixels. The 400 pixels are divided into 25 groups of 16 pixels, i.e. a 5×5 block, each member of which is a 16 pixel group (112). The 16 pixels in each group (112) comprise a 4×4 block of pixels (114) from the 20×20 block. Each 16 pixel group is then averaged to a single piece of information (116), and the block may then be represented by a 5×5 mini block (118), each member of which represents an averaged, usually a rounded, pixel value. In particular each pixel in a mini block corresponds to a rectangle of pixels in the block, and its value is calculated by averaging the pixel values in the rectangle of the block to which it corresponds. When this has been completed for all the big blocks in a frame, the frame will then be represented by a mini frame. This mini frame has a fraction of the number of pixels of the original video frame, so takes a fraction of the memory and can be processed in a fraction of the time that would be required to process the corresponding source frame.

Where the big block has a different arrangement of pixels, i.e. 30×30, or some such, a correspondingly different arrangement of mini blocks is generated, but the principle is the same.

Adjacent Frame Motion Search (AFMS)

In the case where the frame or frames adjacent to the frame being compressed are being used as predictors as in the first three block formats discussed above and also as shown in FIG. 4, the process of encoding frame 1 utilises the nearest earlier frame, frame 0 and the nearest later frame, frame 2, the nearest earlier and later frames being used to predict frame 1, a potentially wide search is appropriate to find a good motion vector estimate. A frame and its nearest earlier frame are considered to be ‘adjacent frames’, as are a frame and its nearest later frame.

With unlimited processor time, all possible motion vectors for the big blocks could be searched to find the optimal match, for example each pixel of a first big block in a first frame could be compared with each pixel of each big block in a second frame until it can be established that an optimal match has been found: i.e. until the location of the best match of the first big block in the second frame has been established. Once the location of the first big block in the second key frame has been established it is possible to determine exactly the motion vector that resulted in the repositioning of the first big block between the first and second frames.

On current typical devices, the resolution and frame rate of the video expected can preclude the possibility of an exhaustive search. Instead, the process is carried out on the mini blocks on corresponding mini versions of the video frames scaled as described above. When a, possibly limited, search is complete using integer ‘average’ pixel motions of the mini blocks, sub pixel motions of the mini blocks are examined to refine the search. The sub pixel motions utilise the averaged information contained in each of the ‘averaged’ pixels in the for example 4×4 pixel group. The small size of these mini frame images reduces the search time and allows a much wider range of candidate motion vectors to be tested in the available time on a real time system, using an error function to estimate any errors over the blocks, to find a candidate best motion vector for each mini block. The error function can be any suitable error function, for example a mean square error function which may apply for example to pixels between the first frame and pixel values from the second frame.

Once a candidate best motion vector is found for a mini block, the process is repeated with new mini-blocks at a larger size—for example four or nine times the previous mini block area, but never exceeding the original block size area. So a 5×5 mini-block could be replaces with a 10×10 mini block covering the same proportion of a larger version of the video frame. Corresponding motion vectors for these larger mini blocks are tested, and an iterative appropriate adjacent motion vector search (IAAMVS) is repeated until a local minimum for the error is found. For example, as shown in FIG. 3 the first larger (20×20) block ‘a’ is contemplated to be positioned at the top left side of the first key frame A. This first larger block ‘a’ is compared as described above with the larger block ‘b’ at the top left side of the second key frame B, and then at three adjacent larger blocks ‘c’ (which are pixel aligned but not necessarily block aligned), for example blocks displaced horizontally, vertically or both an integer number of pixels from block b. This is repeated with the next 5 larger blocks ‘d’ positioned radially outwardly (again pixel aligned and displaced in the manner discussed), and so on. This search looks at these neighbouring possible larger blocks, and corresponding motions, to see if they provide a better match. In particular it is contemplated that each ‘adjacent’ larger block ‘c’ is offset for example one pixel from the larger block ‘b’ to which larger block ‘a’ is compared, similarly each ‘larger’ block ‘d’ is offset one pixel from the larger block ‘c’, and so on. In one implementation, such comparison steps are repeated as long as they give improvements, and for each improvement all nearest adjacent motion vectors are checked, the process ultimately continuing along the best direction. In another implementation, a further refinement of this method allows for comparisons to be carried out further afield to allow escape from local minimum errors which may not be a global minimum. This process of increasing the larger block size and applying the IAAMVS stops when the larger block size is equal to the block size.

So in summary: first, the best available motion vector is found with the smallest mini blocks. Then the block size is increased and the motion vector from the smaller motion blocks is used as the basis for the starting point for a new search for the best available motion vector at this new size. This process is repeated until the motion vector found is based on actual pixels in the unscaled video frame being compressed.

Non Adjacent Frame Motion Search (NAFMS)

In the preferred invention, use is made of motion vectors already calculated for adjacent frames when calculating motion vectors between non adjacent frames, where non-adjacent frames include a first frame and a second frame where the first frame is not the nearest earlier or nearest later frame to the second frame. Examples of non-adjacent frames include frame 0 and frame 2, or frame 2 and frame 4. A consequence of using such already calculated motion vectors is that motion vectors for non adjacent frames are calculated later than those of the adjacent frames. In particular it is contemplated that the motion vectors for the non adjacent frames use the sum of the appropriate motion vectors for frames which are half the time apart as a first estimate of their values, with smaller search spaces around these values to improve the accuracy of the search.

Initial Motion Search Vector Estimation

In one preferred implementation, the frames are decoded by the decoder in increasingly fine temporal granularity, starting with key frames, such as frames 0 and 32 in for example FIG. 1, and then continuing with deltas such as frame 16 in FIG. 1 of increasingly fine resolution (continuing with for example frame 8 and 24, then frames 4, 12, 20 and 28, and so on). This allows the player, if it is short of processor time or bandwidth, to decode only coarser temporal resolution frames.

The motion vectors for the delta frames which are furthest apart (and in this implementation decoded first) are generally the largest, and required potentially the largest search to find the best match. For example, referring again to FIG. 1, a first frame 0 reflects a first frame of a video with a second frame 32 reflecting for example the last frame of the video, the delta frame decoded first will be frame 16, furthest apart from the two key frames 0 and 32. Then frames 0 and 16 will be used to decode frame 8, and so on. Instead of attempting a search from scratch at this temporal resolution, motion vectors of non-adjacent frames are estimated from the motion vectors of the temporally adjacent frames and the set of frames with motion estimates is built up as described below using frames of increasing temporal differences.

As frames F0, F1, F2, . . . arrive for compressing (with Eab representing the motion vector between two earlier frames a and b and Lcd representing the motion vector between two later frames c and d), this is one possible order for calculating the motion vectors:

| | | Motion vectors |
|---|---|---|
| Arriving | Motion vectors | calculated with NAFMS |
| Frame | calculated with AFMS | with initial estimates given |
| 0 | [key frame so no motion | |
| | vector] | |
| 1 | — | |
| 2 | F0-F1 (E01) and F1-F2 (L12) | |
| | [Reconstructing frame 1] | |
| 3 | — | |
| 4 | F2-F3 (E23) and F3-F4 (L34) | F0-F2 (E02) using E01 + L12 |
| | [Reconstructing frame 3] | and F2-F4 (L24) using |
| | | E23 + L34 |
| | | [Reconstructing frame 2] |
| 5 | — | |
| 6 | 4-5 (E45) and 5-6 (L56) | |
| | [Reconstructing frame 5] | |
| 7 | — | |
| 8 | 6-7 (E67) and 7-8 (L78) | 4-6 (E46) using E45 + L56 |
| | [Reconstructing frame 7] | and 6-8 (L68) using |
| | | E67 + L78; |
| | | [Reconstructing frame 6] |
| | | 0-4 (E04) using E02 + L24 |
| | | and 4-8 (L48) using |
| | | E46 + L68 |
| | | [Reconstructing frame 8] |

It can be seen that when the number of frames reaches power of two, all the motion vectors can be estimated from the subdivisions.

For example, a simplified way of considering this process is to consider the raw data of a series of frames beginning with frame 0 and ending with frame 32: the intervening delta frames can be built up in the manner as follows.

First it is helpful to set out a binary representation of the frame number, so that instead of referring in decimal to frames 0, 1, 2, 3, . . . 32 we also refer to them as frames 00000 (0) to 100000 (32), including 00000 (0), 00001 (1), 00010 (2), 00011 (3), 00100 (4), 00101 (5), 00110 (6), 00111 (7), 01000 (8), 01001 (9), 01010 (10), 01011 (11), 01100 (12), 01101 (13), 01110 (14), 01111 (15), 10000 (16), and so on to frame 100000 (32).

Based on the raw data in frame 00000 (0) and 00010 (2) we can generate motion vector estimates that provide frame 00001 (1). Similarly based on the raw data in frame 00010 (2) and 00100 (4) we can generate motion vector estimates that provide frame 00011 (3). This may be generalised such that adjacent frames ending in binary 0 (2, 4, 6 . . . ) provide motion vector estimates for intermediate frames ending in binary 1 (1, 3, 5, . . . ). Thus in a first run through a first estimate is generated for odd frames, from respective adjacent frames.

Zooming out, we can in an analogous fashion generate, in a second run through, motion vectors for frames that end in binary 10 (2, 6, 10, . . . ) from these already estimated motion vectors. For example the motion vector estimates for frame 2 will be based on the values estimated in the first run through, where the motion vectors for frame 1 were estimated based on the raw data of frames 0 and 2, and the motion vectors for frame 3 were estimated based on the raw data of frames 2 and 4. The values generated provide motion vector estimates for frame 2 based on the motion vector estimates of frame 0 to 2 and 2 to 4.

We can in an analogous fashion generate motion vectors that end in binary 100 (4, 12, 20 . . . ), binary 1000 (8, 24, . . . ) then binary 10000 (16). It is important to note that in each case except the initial odd frames case, the motion vector search starts with the estimates based on motion vector estimates of neighbouring values.

Confirmation of Motion Vectors

It is important that the compressor sees exactly what the decompressor will see so that it can find the motion vectors and other corrections which will work best on the decompressor. When the chunk of frames has arrived in the compressor, and the motion vectors estimates have been made as above as part of the process of compression, the motion vectors can be verified, while encoding, before the video bitstream is output, for example transmitted to a decoder. The compression is not loss free, and the frames being compressed are updated to match the video being represented in the bitstream i.e. to what the decompressor produces (the decompressor doesn't have access to the exact original source, but only to a compressed and in general degraded version of it). This can have the effect of making the motion vectors with the best matches on the compressed/decompressed video different from those estimated from the original source. So at this stage, the motion vectors are checked using the estimated motion vectors, but in a different order—namely the order in which the frames will be decompressed, starting with the coarsest temporal resolution deltas. The possibly improved motion vectors are searched for using the same search techniques as the original estimates used, but with the decompressed frames replacing the original source frames. Where a better match is found, this replaces the original motion vector estimate.

Bias

Modern mobile phone cameras can have an auto exposure function, which can change the values of pixels while preserving their relative values. Rather than update all the pixels individually, the compressor may adjust Y values by, for example, calculating the average values of Y over each motion block and adjusting for this in the bitstream as a single value for each block. This allows any Y bias in the block estimate to be corrected efficiently, if required.

Block Representations

There are four classes of block representations, or block types, supported by the compressor, making use of information available at the time of decompression:

1. Interpolated. These are based on the average between motion adjusted and bias adjusted blocks from the temporally closest known past and future video frames. For example this block type is suitable where there is some or no motion within a frame between the past and future video frames.

2. Earlier. These are based on the motion adjusted and bias adjusted blocks from the temporally closest known past video frame. For example this block type is suitable where there is motion near an edge of a frame, for example where motion near an edge of a frame in the temporally closest known past video frame will no longer be present in the temporally closest future video frame.

3. Later. These are based on the motion adjusted and bias adjusted blocks from the temporally closest known future video frame. For example this block type is suitable where there is motion near an edge of a frame, for example where motion near an edge of a frame in the temporally closest future video frame is new, i.e. not present in the earlier frame.

4. Intraframe. These are based on high quality intraframe compression. For example this block type is suitable where a small item or part of a frame is moving while the rest remains relatively stable, for example where the video covers a tennis match and the motion of a ball is followed through frames, i.e. when the motion search fails to find a good match from either the previous or later frame for this block.

Cases 1-3 allow for arbitrary pixels to be corrected. The corrections are typically small, so compress well, and in the preferred implementation of the invention are chosen to give more accurate representation in lower contrast areas. In one implementation, these blocks are split up and the variance in each section is used to represent the smoothness. In another implementation, the local contrast is calculated explicitly, and this value is used to set a maximum allowed error for each pixel.

Case 4 allows for filtering of the image to reduce noise, and hence data-rate. When this option is enabled, the filtering generally reduces the contrast of pixels which have locally outlying values, and hence which are more likely to be accentuated by noise. Reducing the contrast in this way has minor effects on the perceived image quality but gives a good saving in data rate.

The bitstream for the delta frames contains information such as the larger block size (i.e. 20×20, 30×30, and so on, as shown above); and also the block type for each block. For types 1-3, for each larger block the bitstream also contains information such as motion vectors, bias, identification of each pixel to be corrected (by for example sending the gap from the previous correction) and corrections to any estimates which used earlier or later frames. For type 4, the bitstream contains a high fidelity representation of each pixel in the block.

Accuracy

Because some (delta) frames are constructed from other (key or delta) frames, the frames used as sources by most other frames (key frames and some delta frames) should be more accurately represented than the remaining frames. The choice of block representation (i.e. block type) is dependent on the accuracy required, with type 4 being used when types 1-3 are insufficiently accurate. The error rate acceptable where options 1-3 (lower data rate options) are selected is lower on delta frames which decoded earlier, and are used in the construction of a higher number of subsequent delta frames, and highest on delta frames which are decoded last, and not used in the construction of any further delta frames, as this reduces the average error rate for a given datarate. Where the blocks are far apart in time and will be used to generate multiple further blocks at decreasing separation, accuracy is required so any errors are not propagated over multiple frames.

The acceptable error can also depend on the variance within the block, where variance is a result of for example contrast within the block, with less varied blocks requiring a more accurate fit.

The compressor generates its corrections using only the information available to the decompressor so that the data sent to the decompressor applies to the information at the decompressor's disposal. This is significant because the information sent is most useful to the decompressor and is independent of any additional information the compressor may have available to it (but which is not available to the decoder).

Sub Pixel

Sub pixel motion can be simulated by averaging two motion blocks each with motion vectors which are an integer number of pixels horizontally and vertically, and which are for example either side of the correct motion. This means that averaging the blocks from earlier and later frames can result in estimates of sub pixel motion.

Temporally close together frames with motions of an integer number of pixels often give the effect of appearing to have sub pixel motion when averaged. Hence the motion estimates between past and future can be chosen to be integer numbers of pixels in such a way that the averages between past and future frames in type 1 blocks effectively gives sub pixel motion estimation—but, importantly, without having to send or search for sub pixel motion vectors.

Transition Tables

In a preferred implementation of the invention, the bitstream encoding uses Forbidden's previously patented loss free “transition table” technology.

Some Advantages of Temporal Compression as Described in this Patent

Firstly, substantially every part of the contents of a middle frame is likely to be represented either as part of a previous frame, or as part of a future frame, or both. This means that representing a delta frame between two key frames almost always does not require completely new pixels to allow for motion, particularly camera motion.

Secondly, the use of averaging simulates sub pixel motion without the computational or data rate costs of sending it explicitly—integer only motion vectors suffice.

Thirdly, for editing or low data rate connections, video can be downloaded and played back easily at a wide range of frame rates without requiring download or decompression of non-displayed frames.

The advantages are not limited to those outlined herein.

The invention is not restricted to the details of the foregoing embodiments. For example the number of frames between key frames may not be a power of two, but may be any other number, and determining the content of delta frames between key frames separated by a number other than the power of two may involve subdividing the time by a different, more suitable number.

1-53. (canceled)

54. A method of encoding a series of frames in a video or media, the method comprising:
receiving a first key frame,
receiving subsequent chunks of frames including at least one key frame,
dividing each frame into a plurality of blocks,
subdividing a first block of the plurality of blocks into a plurality of pixel groups,
averaging the pixels in each of the pixel groups to generate a single value,
creating a first mini-block having elements, wherein each element of said first mini block corresponds with one of the pixel groups of the corresponding first block and contains said single value,
repeating the steps of subdividing, averaging and creating a mini-block for each block of each frame of the chunks, therein creating a plurality of mini-blocks for each of the frames, and
comparing a first of said plurality of mini blocks of a first one of the frames with mini blocks of a second one of the frames, and matching the first of said plurality of mini blocks with one of the mini blocks of the second one of the frames based on the comparing.

55. The method as claimed in claim 54, further comprising generating one or more respective motion vectors that map respective mini blocks of the first frame onto respective achieved matching mini blocks of the second frame.

56. The method as claimed in claim 55, wherein said motion vectors are based on a temporally earlier and a temporally later frame, relative to said second frame of said chunk of frames.

57. The method as claimed in claim 55, further including one or more of:
filtering motion artefacts after generating said one or more respective motion vectors;
dividing each of the frames into the plurality of blocks by dividing each frame into a number of blocks sufficient to ensure each block has a match on an earlier, a later frame, or both an earlier and later frame;
dividing each of the frames into the plurality of blocks by providing all of the blocks in each frame as being the same size; and
a combination of the above.

58. The method as claimed in claim 55, wherein generating the one or more motion vectors includes generating motion vectors by:
for each frame where the binary number of the frame ends in a ‘1’, generating the motion vectors in a first pass at a first magnification from raw data of said frame and from temporally adjacent, neighboring frames;
for each frame where the binary number of the frame ends in a ‘10’, generating the motion vectors at a second, less granular, magnification relative to an earlier motion vector;
for each frame where the binary number of the frame ends in ‘100’, ‘1000’, 10000, or larger powers until the last power of two which is not a key frame; generating the motion vectors at less granular magnifications relative to earlier motion vectors until a final motion estimate for the frame mid-way between the first and last frame is provided which depends on earlier motion vectors, such that each motion vector is based on values calculated from neighboring motion vectors.

59. The method of claim 55 including the further step of, before the frames of a particular one of the chunks are encoded for transmission,
reconstructing the video from a compressed version of the chunk by applying the motion vectors thereto;
comparing the result to the frames as they are decompressed;
adjusting the motion vectors to obtain a result indicative of a match; and
replacing original ones of the frames to be compressed with the resulting decompressed frames.

60. The method as claimed in claim 54, wherein the matching of the first of said plurality of mini blocks with one of the mini blocks of the second one of the frames is based on an error function.

61. The method as claimed in claim 54, wherein said first frame is a temporally earlier frame than said second frame of said chunks of frames.

62. The method as claimed in claim 54, wherein said first frame is a temporally nearest earlier frame to said second frame of said chunk of frames.

63. The method as in claim 54, further comprising recalculating each mini block of the first frame to be an integer multiple larger, to provide a larger mini block, and comparing each larger mini block of said first frame to one another, starting in the vicinity of the matched mini block of the second frame.

64. The method as claimed in claim 63, wherein the recalculating step is repeated until the mini block size is the same as the block size, and each pixel being compared is an original pixel not an averaged pixel.

65. The method as claimed in claim 54, wherein said step of comparing a first of said plurality of mini blocks of a first frame with respective mini blocks of a second frame includes comparing said first mini block with a mini block in a corresponding position in a second frame, then comparing said first mini block with a block in said second frame with a pixel displacement where both the horizontal and vertical components of the pixel displacement are integer numbers of pixels from said mini block in a corresponding position in said second frame.

66. The method as claimed in claim 65, wherein said pixel displacement is in a vertical direction, in a horizontal direction, or in both a horizontal and a vertical direction.

67. The method of claim 54, further including encoding said series of frames by providing a key frame and motion vectors based on the comparing.

68. The method of claim 67, wherein encoding said series of frames includes providing block information.

69. The method of claim 68, wherein the block information includes block size, block type, or both block size and block type, and wherein the block type indicates whether a frame earlier than said second frame, a frame later than said second frame, or both earlier and later frames that can be used to generate separate vectors.

70. The method as claimed in claim 54, wherein said comparing step includes identifying remote matches.

71. The method as claimed in claim 54, further including utilizing an error function to estimate errors over the blocks.

72. The method of claim 54, further including the step of transmitting an encoded series of frames from one of the chunks, with at least one key frame and motion vector, to a decoder for reconstructing the chunk.

73. The method of claim 54, further including the step of adding additional data while encoding a series of the frames, from bias information, gaps to correction, and corrections to temporal estimates.

74. A method according to claim 54, further including:
receiving a compressed key frame and at least one subsequent compressed encoded data chunk, including motion vector data; and
applying relevant motion vectors to either one or both of the key frames, or using other encoded intra frame data, to reconstruct a first delta frame.

74. The method of claim 54, where the mini blocks in the second frame are not aligned to the mini blocks in the first frame.

75. The method of claim 54, wherein the matching the first of said plurality of mini blocks with one of the mini blocks of the second one of the frames is based on error characteristics between respective pixel values of each of the first of said plurality of mini blocks and the one of the mini block of the second one of the frames.

76. An apparatus comprising:
coding circuitry configured and arranged to decode a received compressed video or other media data, said compressed data including at least two key frames and information identifying, for frames compressed in said compressed data, a block size and for each block a block type, said block type indicating whether a first frame to be reconstructed is based on zero, one of two of an earlier or later second frame in said compressed data, motion vectors and other data; and
logic circuitry configured and arranged to reconstruct frames by applying said motion vectors to said compressed data.

77. The apparatus of claim 76,
further including mobile telephone circuitry that includes the decoding circuitry and the logic circuitry;
wherein the key frames include a first key frame and at least one additional key fram in chunks of frames received by the decoding circuitry;
wherein the logic circuitry is configured and arranged to reconstruct the frames by:
dividing each frame into a plurality of blocks,
subdividing a first block of the plurality of blocks into a plurality of pixel groups,
averaging the pixels in each of the pixel groups to generate a single value,
creating a first mini-block having elements, wherein each element of said first mini block corresponds with one of the pixel groups of the corresponding first block and contains said single value,
repeating the steps of subdividing, averaging and creating a mini-block for each block of each frame of the chunks, therein creating a plurality of mini-blocks for each of the frames, and
comparing a first of said plurality of mini blocks of a first one of the frames with mini blocks of a second one of the frames, and matching the first of said plurality of mini blocks with one of the mini blocks of the second one of the frames based on the comparing.

78. The apparatus as claimed in claim 76, wherein the logic circuitry is configured and arranged to reconstruct delta frames from key frames and said motion vectors.

79. The apparatus as claimed in claim 76, wherein the logic circuitry is configured and arranged to reconstruct delta frames utilizing additional data.

80. The apparatus as claimed in claim 79, wherein the coding circuitry is configured and arranged to receive said data key frames first, followed by motion vectors for constructing delta frames therefrom.

81. The apparatus as claimed in claim 76, wherein the logic circuitry is configured and arranged to reconstruct delta frames until all the frames have been reconstructed.

82. The apparatus as claimed in claim 76, wherein the coding circuitry is configured and arranged to receive compressed data including an integer number of frames.

83. The apparatus as claimed in claim 82, wherein the integer is a power of 2.

84. The apparatus as claimed in claim 76, wherein the logic circuitry is configured and arranged to generate a video or media stream by reconstructing delta frames.
